(19) United States
(12) Patent Application Publication
(10) Pub. No.: US 2005/0108023 A1
(43) Pub. Date: May 19, 2005

(54) Methods and systems for producing and/or distributing electronic publications

(76) Inventor: Chris Hemmings, Hong Kong (CN)

Correspondence Address: JACOBSON HOLMAN PLLC, 400 SEVENTH STREET N.W., SUITE 600, WASHINGTON, DC, 20004, US

(21) Appl. No.: 10/706,267

(22) Filed: Nov. 13, 2003

(51) Int. Cl. G06F 17/60

(52) U.S. Cl. 705/1

(57) ABSTRACT

This invention relates to systems and methods for producing or providing electronic publications. A client wanting an electronic publication and obtain access to server across the Internet to request the compilation of an electronic publication. The client may provide the source files in the form of standard format files such as .PDF files and these may be used to generate an electronic publication, preferably in assembly language, incorporating additional technology such as a compiled multi-page document with a page-turn. Rather than supply software to the client for the client to produce their own publications, the client may pay as they go with a transaction taking place with each new file compiled. This also reduces the need to support distributed software and makes incrementally developing features of the software available to all clients upon introduction of the features into a group of selectable features for inclusion in the executable program forming the publication.

### FIELD OF THE INVENTION

This invention relates to systems and methods for producing and, if desired, distributing electronic publications. A system and method is generally described with reference to Internet and e-mail communication although other means of electronic communication are possible.

### BACKGROUND TO THE INVENTION

Following on from the widespread use of personal computers and interconnectivity through the Internet and the e-mail systems, considerably greater quantities of information are being distributed in electronic form.

The majority of electronic publications occur on the worldwide web and are accessed through Internet browsers. An alternative form of publication uses an e-mail system to circulate documents, usually in the e-mail itself or, on occasions, using an attached file such as a file in PDF format suitable for viewing with applications such as Adobe Acrobat.

Despite the volume of electronic publications now available, they have not significantly altered the presence of written publications in the form of newspapers, magazines and brochures for advertising. Part of this is due to the difficulty in emulating print media on line. The restrictions of HTML programming and the differences between different Internet browsers or personalized settings within a reader's browser tend to cause different presentations of the document on different computers. The layout of the page is not entirely over to the publisher to determine as portions of any particular page of information may be beyond the screen and require use of the scroll bar or similar to view. This may detract from useful advertising space on a page and any assurance that a reader will view that advertisement upon viewing the page.

Another difficulty with electronic publications in the form of documents on the worldwide web is that the publication itself is continuously changing. For example, in the case of a website to a typical newspaper, a reader will view the articles presented on that particular day and any desire to retain or source articles from previous days requires searching archive directories on the website. Although a user may subscribe to certain publications, they do not generally receive a complete electronic publication which provides them with some sense of possession of the document in return for their subscription.

To improve on some of these aspects, different forms of electronic publication have been devised. An example of such a publication is contained in international patent application No. PCT/IB01/01621. It can be seen that this provides a document in the form of an executable file in which both the source material and the application to run the publication in the manner intended are combined. Such publications include increasing amounts of technology.

Despite the improvement in the publications themselves, typical methods of producing such publications would involve the distribution of software to produce such publications and electronic publishers utilizing the software provided to produce their own publications. The distribution of the software is normally done as part of a licensing regime.

The difficulty in distributing software applications in this manner concerns the need to constantly maintain, upgrade and support the software application, particularly as the technology may continue to evolve with additional features being provided in each subsequent release of the software. An example of the difficulties can be seen with such software as the Adobe Acrobat software in which both the publishers having full versions of the software and the reader base requires at least a basic form of the application to read the files. Generally small incremental improvements to the technology are held back until sufficient exist to release an upgrade version which then needs to be distributed around all the publishers and the reader base if it is intended to ensure that the new technology is available to all and to avoid the difficulties of forward and backward compatibility with numerous different versions of a software package being utilized.

The need for maintenance and support of the applications as their age significantly detracts from any revenue gained through normal licensing of software and often leads to the discontinuance of support for applications after a relatively short period of time. Coupled with the difficulties with software policy etc., an alternative method of distributing applications or delivering such business solutions may be desirable.

### OBJECT OF THE INVENTION

It is an object of the present invention to provide method and/or system for producing and/or distributing electronic publications or software applications in general that will overcome some of the disadvantages of the prior art or at least provide the public with a useful choice.

### SUMMARY OF THE INVENTION

Accordingly, in the first aspect, the invention may broadly be said to consist in a method of producing an electronic publication comprising:
obtaining electronically formatted source files from a client;
obtaining information from the client on preferences on technology to be embedded in the publication;
compiling said source files into an electronic publication incorporating said preferred technology, and
providing said publication to said client and/or third parties.

Preferably a method of producing an electronic publication as claimed in claim 1 wherein said source files are obtained through transmission by said client over the Internet or electronic mail from a remote location.

Preferably said client interacts via a website on the Internet.

Preferably said client selects technology to be embedded in said publication via a website on the Internet.

Preferably said client enters into a transaction for the compilation of the electronic publication.

Preferably said transaction includes payment for the compilation of the publication through an electronic payment mechanism on or linked to said website.

Preferably said electronic publication includes a multi-page document having a page turn.

Preferably said available preferred technology includes the embedding of a font for at least part of the content of the publication.

Accordingly, in a second aspect, the invention may broadly be said to consist in a method of providing electronic publishing services comprising:
providing a website on the Internet for access by clients;
requesting or receiving source files from said clients by electronic communication;
compiling said source files into an electronic publication; and.
delivering said electronic publication to said client or a third party.

Accordingly, in a further aspect, the invention may broadly be said to consist in a system for producing an electronic publication comprising:
obtaining electronically formatted source files from a client by electronic communication;
obtaining information from the client on preferences for tools or operations of said publication;
compiling said source files into an electronic publication incorporating said preferred tools or operations; and
providing said publication to said client and/or third parties.

### BRIEF DESCRIPTION OF THE DRAWINGS

Preferred embodiments of the invention will now be described with reference to the following drawings in which:

FIG. 1 provides a schematic view of hardware that may be utilized in accordance with an embodiment of the invention;

FIG. 2 provides a schematic view of the general operations of a method in accordance with a preferred embodiment of the invention; and

FIG. 3 provides a basic flowchart of operations of a method in accordance with the invention.

### DETAILED DESCRIPTION OF PREFERRED EMBODIMENTS

The invention relates to systems and methods for producing and distributing electronic publications as well as, potentially, other software applications.

In a preferred embodiment, the invention is directed to a method and system for producing and, perhaps, distributing electronic publications. Electronic publications have progressed from simple text documents to more technologically evolved forms of publications such as those described in international patent application No. PCT/IB01/01621.

Taking this type of publication as an example, the publication in that document comprises text and images arranged into a document containing a page-turn. Such technology is embedded in the published document as a single software application. Both the document and the application software are combined together so as to avoid the need for users to have particular readers for the file format provided.

In providing such a publication, files may be prepared using a suitable editor or the text and image layout could be provided in a relatively standard format such as PDF or other common formats. The document is then converted to the particular format of the application, complied and produced as a complete document.

Normally, software applications of this type would be distributed and licensed so that purchasers could produce their own publications and distribute these as they wish. In the context of conventional print production, this is the equivalent of selling a printing press to produce the document itself.

Like all computer software, the technology included in such applications may improve, evolve and change overtime. Additional facilities can be provided in upgrades and the software supported in the same way as conventional software. However, this produces all the difficulties of providing such support.

The present invention provides an alternative method. The method involves obtaining source files from the user desiring such a publication whereby the source files need to contain little more than the text and images themselves. Of course, to replicate page layout of the users' files, some compatibility in formats may be necessary. In doing so, source files may be obtained in suitable formats such as PDF files produced by Adobe Page Maker or an editor program distributed in its own right to suit the publication format.

The source files may then be transmitted to a compiler that obtains the source files, compiles the publication in the manner desired and may then return the publication to the user. Having received a complete publication, the user may then copy the publication as desired and distribute.

This method in its most basic form allows a user to provide source files to a separate party to prepare the publication and this may be done with the latest version of the publication producing software to obtain any and all enhancements and developments as may be desired by the user. Furthermore, the user may utilize conventional publishing software to format the source files and provide them in formats suitable for use by the compiler. This allows standard format documents to be used as a source of material to be incorporated into advanced publications.

Furthermore, in his simple form, a user may be charged for the compilation of publications on a unit charged per publication, per page, etc. This is an alternative to providing and selling the application to compile the documents itself in obtaining a licence fee through that sale to pay for ongoing support.

In this initial embodiment, the hardware components merely comprise the users' own computer, a communication system for the electronic files, the compiler's own computer to prepare the publication and return the publication also via the same or a different electronic communication medium. In reality, the method itself may be suitable for use over the Internet to provide online compilation of publications together with online payment so as to include additional parties that may separately provide services in relation to electronic commerce.

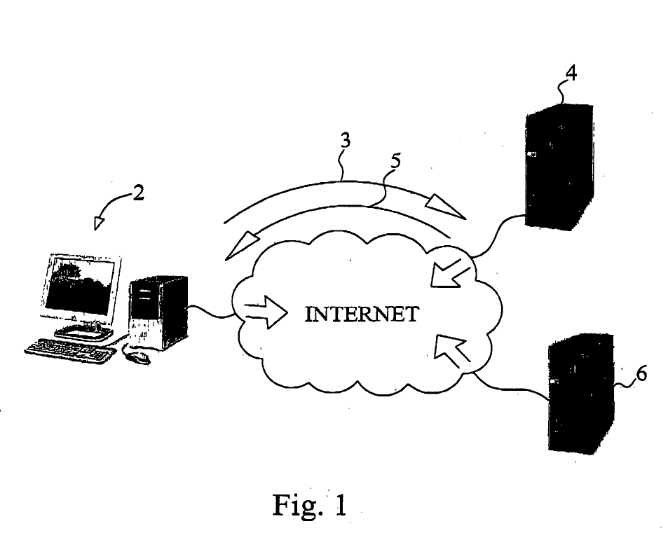

The first embodiment of the invention is shown in FIG. 1. The system may utilize a user operating a personal computer or similar to electronically transmit source files 3 to a server 4 for the compilation. Typically this electronic transmission may also be performed across the Internet through a suitable user interface so that the user may also select various options that may be available in the form of the publication as compiled.

Once compiled, the publication in the form of a software application may be returned electronically to the user's computer 2 as a complete publication 5. Typically, an initial publication would be returned to the user for review and the passage of the publication between the user and the compiler may be an interest process while corrections are made.

Upon completion of suitable file 5, this may be returned to the user's computer 2 for subsequent distribution to a readership or, alternatively or additionally, pass to an electronic distribution provider that may be linked with the compiler or an external source.

The method of this particular invention anticipates the use of a page on a worldwide web as an interface for a user to request compilation of a publication, provide the source files and make such selections as may be available in the technology incorporated in the application. As this method also envisages payment for compiling the application as opposed to providing a complete software package for independent compiling of a program, a payment mechanism may also be incorporated in the user interface on the Internet. Many such payment mechanisms already exist with payment being by credit card, electronic credit or otherwise.

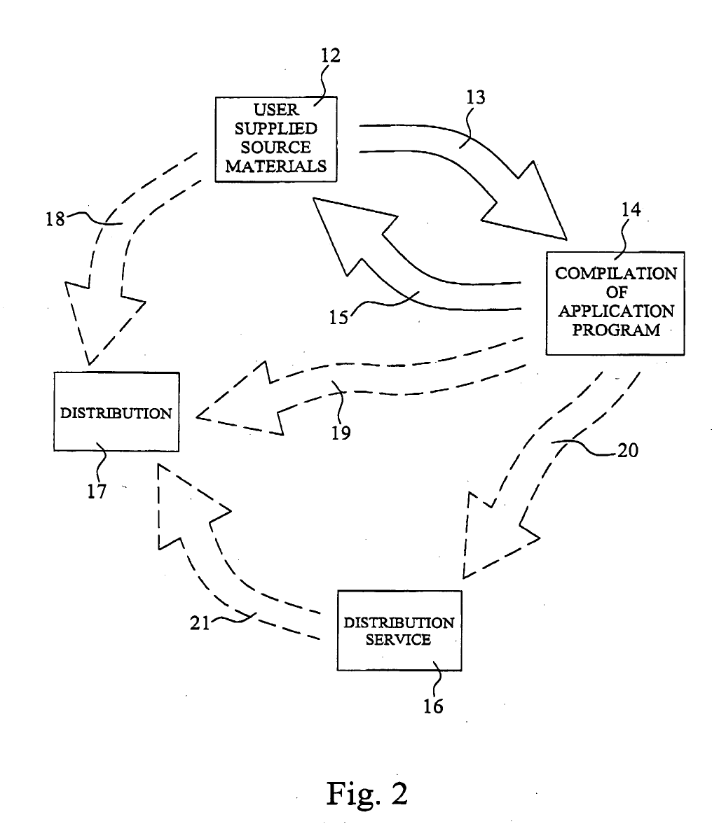

Referring to FIG. 2, the schematic diagram of the operations can be seen. Users supply source materials to be electronically transmitted for compilation of the application program. This program may be returned to the user by electronic transmission 15 or directly distributed or passed to a distribution service, again generally electronically as an electronic file 20.

If the compiled program is to be distributed by the user, this may also be performed electronically.

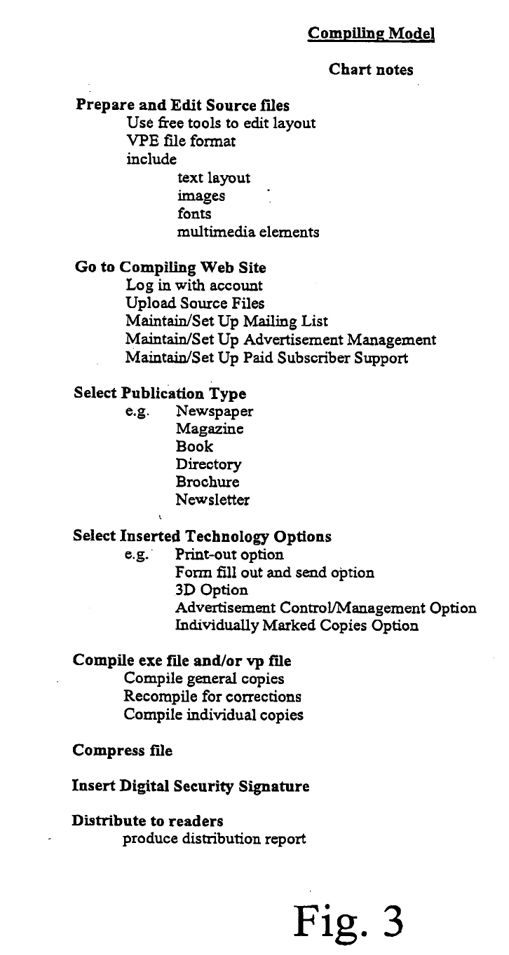

The preferred form of this invention provides an electronic publication including a page-turn or other technological advances. FIG. 3 provides a flowchart of some principal operations in the method.

The preparation and editing of source files including text and media files may be performed using a specific editor compatible with the compiler of this preferred embodiment. The compiler of the preferred embodiments puts together a page-turn publication. Alternatively, the source materials may be provided in other standard format such as PDF.

Although the text layout and page layout may be provided in PDF format, individual media items referenced on the pages may be in other formats suitable for images, sound, video or animations and a variety of multimedia file formats may be included in the finished document.

Typically a user would access and communicate with the compiler via an Internet website address. A user may log in to the website on which a specific account may be set up for that user. This allows user information to be retained from one transaction to the next and minimizes the need for new information to be provided.

Upon logging in, the user may provide the source files in suitable formats. If the compiler is also acting as a distribution agent, the user may have access to other services such as a distribution mailing list that they may maintain or set up, an advertising management program or a paid subscriber database. Of course, numerous other peripheral services may be provided.

A user may nominate the type of publication they want the source files may be compiled into. Although the preferred form of this invention provides a page-turning publication, there may be different general styles of publication such as newspapers, magazines, books, directories, brochures or newsletters that may determine some of the layout options.

The preferred form of this invention also contemplates a variety of different technology options to be incorporated into the application. For example, some users may wish the readers to be able to print out the publication in hard copy and hence a printout option may be selectable. Another possible option involves the filling out of forms within the publication. It will be appreciated that many magazines have subscription information or forms to be filled out in response to advertising or similar. As the option to insert information into the publication and send a copy of that information in response requires additional technology in the page-turn publication product, the file size may be reduced or the complexity of the publication may be reduced if this option is not selected. It is available to those users that may wish such an option.

A further option may include the embedding of specialized fonts. This may be particularly desirable for newspaper clients that often have quite specific font sets for their publications. These font sets may not be compatible with the standard fonts found in Windows or similar major operating systems and the user may wish to embed the font file with the publication. Of course, where the document is to be sent out to a subscriber list or standard mailing list, the user may only wish the font file to be embedded to new subscribers or recipients as the others may have already received the font with earlier versions of the publication. This may lead to some individualization of copies of the final product.

A 3-dimensional option may also be provided. The technology may include the provision of a 3-dimensional version of the publication that may be rotated around the various axis of an imaginary 3-dimensional sphere.

Various advertisements embedded within the publication may require their own specific technology whether this be by the format of the source file for the advertisement or standard options to place different advertisements on different copies and individualize copies of the final publication. Indeed, individualization of the copies itself may be a technology selected by a user.

The option for users to copy actual content of the publication is yet a further tool or technology option available to a user. It is possible for the publication to exclude an ability for a final recipient of the product to directly copy a text or images from the publication.

The content of the source files may determine whether full multimedia options are necessary. For example, if only text and images are utilized, there is no need for the publication to contain unnecessary code to provide sound with the publication.

The ability to select various technologies into the publication allow the compiled program to be minimized in its size is not all the options need be available on all publications. Furthermore, as additional technology is provided and additional tools, operations or preferences are available to a user, these merely need to be introduced on the website. There is no need to upgrade any software the user has directly as they merely select the option and the compiled program will incorporate any necessary code.

Upon having made all the necessary selections, a user may then request the compiled file. The source materials may be passed to the compiler together with the option selected to compile a suitable program file.

The program file in this preferred form may be provided as an executable file or as a file under its own file format. In providing a page-turn publication encompassing a variety of technologies and in an attempt to minimize the size of the file, 16 bit assembly code is used for the publication itself. This would typically be provided as an executable file although many recipients of the publication do not like receiving executable files even with suitable digital signatures due to the virus risk associated with executables. Many firewalls for example will block such files.

To overcome this, a suitable file format may be used and associated with a reader file sent out to or downloadable by recipients. Although the user of a reader file is somewhat contrary to the intent of the invention, a suitable reader file that merely acts as a start-up for the program and does little more than change the file format to an executable to run the program still overcomes the disadvantages mentioned earlier with versioning of reader files as technology increases. The technology is embedded in the publication program itself and does not need to be provided in the reader file. The reader file is merely a start-up file so that file formats other than “.exe” can be used.

Upon compilation of the program, this may optionally be returned to the user for review prior to any distribution. In a publishing context, it is normal to send a document to a client for review prior to completion of the final publication. Any errors noted by the user can be corrected and the eventual publication recompiled.

If the user is also utilizing an optional distribution service associated with the compilation of the program, individual copies in accordance with the rules of the distribution lists may be prepared.

In the preferred form of this invention, the publication comprises a page-turn publication built in an assembly code making the file size very small despite the large amount of calculations performed to provide accurate visualization of the publication on a computer screen. Therefore, there may be no need to compress the publication itself although attached source files may require compression to minimize the file size of the publication itself. This compression may be done in the initial compilation or subsequently, just prior to distribution.

It can be seen from FIG. 3 that the insertion of a digital security signature to provide some authentication to the program can be provided. This is particularly important for executable files.

Finally, as shown in FIG. 3, the publication can be distributed to the ultimate recipients or returned to the user for their own distribution.

It will be appreciated that the steps involved in the compilation of the program will be associated with a suitable payment mechanism, particularly as this may be provided through a website. Charge can be made through typical electronic transaction methods and may vary according to the technology inserted, the amount of compiling required or the distribution of copies.

Thus it can be seen that this invention provides a method by which computer software may be tailored to an individual user's requirements, compiled and provided over the Internet and charged on the basis of the compilation. This is in direct contrast to the typical business model for computer software in which editing and publication compiling programs would be sold to users and each user would require maintenance, support and may not be using or have available the latest technology. This preferred form of the invention provides a technology on demand as any new feature or tool available in a publication in accordance with the preferred form of the invention can be made available on the website for immediate selection.

When applied to electronic publications, the present invention also places the business model, provision of services and technology much closer to conventional printing techniques for paper publications. Most magazines and other publications are not printed by the publisher. Instead, the publisher prepares the content and provides this, often in the form of PDF files or similar, to a printer that produces the actual publication. If advances in technology allow improvements in the printing process, a printer would typically have these available to the user. In a parallel sense, the present invention allows electronic publications to be outsourced for compilation of the publication itself and the technology to be inserted by the compiler rather than requiring input or specific technology held by the publisher.

1. A method of producing an electronic publication comprising:
obtaining electronically formatted source files from a client;
obtaining information from the client on preferences on technology to be embedded in the publication;
compiling said source files into an electronic publication incorporating said preferred technology, and
providing said publication to said client and/or third parties.

2. A method of producing an electronic publication as claimed in claim 1 wherein said source files are obtained through transmission by said client over the Internet or electronic mail from a remote location.

3. A method of producing an electronic publication as claimed in claim 1 wherein said client interacts via a website on the Internet.

4. A method of producing an electronic publication as claimed in claim 1 wherein said client selects tools to be embedded in said publication via a website on the Internet.

5. A method of producing an electronic publication as claimed in claim 1 wherein said client enters into a transaction for the compilation of the electronic publication.

6. A method of producing an electronic publication as claimed in claim 5 wherein said transaction includes payment for the compilation of the publication through an electronic payment mechanism on or linked to said website.

7. A method of producing an electronic publication as claimed in claim 1 wherein said electronic publication includes a multi-page document having a page turn.

8. A method of producing an electronic publication as claimed in claim 1 wherein said available preferred technology include the embedding of a font fox at least part of the content of the publication.

9. A method of providing electronic publishing services comprising:
providing a website on the Internet for access by clients;
requesting or receiving source files from said clients by electronic communication;
compiling said source files into an electronic publication; and
delivering said executable electronic publication to said client or a third party.

10. A system for producing an electronic publication comprising:
obtaining electronically formatted source files from a client by electronic communication;
obtaining information from the client on preferences for tools or operations of said publication;
compiling said source files into an electronic publication incorporating said preferred tools or operations; and
providing said publication to said client and/or third parties.
